(19) United States
(12) Patent Application Publication
(10) Pub. No.: US 2019/0282931 A1
(43) Pub. Date: Sep. 19, 2019

(54) BUBBLE REMOVING DEVICE AND COATING APPARATUS

(71) Applicant: Wuhan China Star Optoelectronics Semiconductor Display Technology Co., Ltd., Wuhan, Hubei (CN)

(72) Inventor: Ying ZHENG, Wuhan, Hubei (CN)

(21) Appl. No.: 15/740,721

(22) PCT Filed: Dec. 13, 2017
(86) PCT No.: PCT/CN2017/115999

§ 371 Date: Dec. 28, 2017

(30) Foreign Application Priority Data
Nov. 7, 2017 (CN) 201711082947.1

(51) Int. Cl. B01D 19/00; B01D 19/02; B05C 11/10

(52) U.S. Cl. CPC B01D 19/0078; B05C 11/10; B01D 19/02

(57) ABSTRACT

This invention provides a bubble removing device. The device comprises a first container, a second container disposed in the first container, and an ultrasonic generator, wherein the second container is smaller than the first container, the first container and the second container are divided into a first cavity and a second cavity individually, and the first cavity and the second cavity are not connected with each other; wherein the first cavity contains water, the second cavity contains solution, and an outlet pipe, an inlet pipe, and an air vent are arranged in the second cavity in the second container. This invention also provides a coating apparatus comprises the aforesaid bubble removing device in the coating apparatus the outlet pipe is connected with the sprayer and the inlet pipe is connected with the storage container.

### RELATED APPLICATIONS

The present application is a National Phase of International Application Number PCT/CN2017/1.15999, filed Dec. 13, 2017, and claims the priority of China Application 201711082947.1, filed Nov. 07, 2017.

### FIELD OF THE DISCLOSURE

This invention is related to LCD manufacturing technology, especially relates to a bubble removing device and a coating apparatus.

### BACKGROUND

The flexible display is a display device with a flexible substrate. Due to the bendability, the wide vision angle, and compact size, the flexible display is a very promising product in the market. In the conventional technology, the flexible substrate can be thin glass, plastic film or metal foil.

Polyimide (PI) is a polymer with imide as a monomer. It has several advantages, such as wide thermal adaptability, anti-corrosion, high mechanical strength, and high isolation. PI has been widely used in aviation, aerospace, microelectronics and other fields. At present, PI has been applied in flexible electronic as a flexible substrate material.

In the development of PI and its application on OLED device. PI is usually applied on a glass substrate with a slit coating technology and dried and baked in an IR oven.

However, there are a lot of micrometer-sized bubbles dispersing in the PI solution, and there are limited ways to removing the bubbles before coating. With reference to FIG. 1, the bubbles will migrate to the surface of PI film to form air bags at high temperature vacuum drying or IR baking stage. Those air bags might collapse or pop up in the following array manufacturing process and the upcoming processes will be affected accordingly. To remove those bubbles, vacuuming or stirring are the mainstream processes.

One of the bubbles removing process is placing the PI solution in an vacuum environment. However, N-Methylpyrrolidinone (NMP) will be vaporized in the vacuum environment due to its low boiling point. NMP vaporization might incur the concentration of PI and thickness of PI film are deviated. Another bubble removing process is stirring the IP solution for 16-18 hours and venting clean nitrogen to bring the bubbles out. This way takes more time and is not effective in production.

### SUMMARY

To overcome the disadvantages of the current technology, this invention provides a bubble removing device and a coating apparatus to realize the bubble removing in the solution.

This invention provides a bubble removing device. The device comprises a first container, a second container disposed in the first container, and an ultrasonic generator, wherein the second container is smaller than the first container, the first container and the second container are divided into a first cavity and a second cavity individually, and the first cavity and the second cavity are not connected with each other; wherein the first cavity contains water, the second cavity contains solution, and an outlet pipe, an inlet pipe, and an air vent are arranged in the second cavity in the second container.

Preferably, a filter connected with the outlet pipe.

Preferably, the second container is arranged beneath the first container.

Preferably, the ultrasonic generator is disposed on the bottom of the first container.

Preferably, the air vent is connected with an air evacuation valve.

Preferably, the inlet pipe is connected with a liquid inlet valve.

Preferably, the inlet pipe is connected with a first pump.

Preferably, a second pump connected with the outlet pipe, and disposed between the filter, the second container.

This invention also provides a coating apparatus comprises the aforesaid bubble removing device. In the coating apparatus the outlet pipe is connected with the sprayer and the inlet pipe is connected with the storage container.

Comparing with the conventional technology, the second container is arranged beneath the first container and the ultrasonic generator is disposed on the bottom of the first container. The first container and the second container are divided into a first cavity and a second cavity individually, and the first cavity and the second cavity are not connected with each other. The first cavity contains water, the second cavity contains solution and an outlet pipe, an inlet pipe, and an air vent are arranged in the second cavity in the second container. By the vibration produced by the ultrasonic generator, the water as the intermediate material will deliver the cavitation effect to the PI solution in the second container. The gas in the PI solution will gather to form fine bubbles. The fine bubbles will combine to form ball shaped bubbles and leave the PI solution. This realizes gas removing in PI solution and improves the throughput, and this also control the vaporization of the solution with low boiling point to ensure the PI concentration is stable.

### BRIEF DESCRIPTION OF THE DRAWINGS

FIG. 1 is a schematic structural view of the present invention.

### DETAILED DESCRIPTION OF PREFERRED EMBODIMENTS

Hereinafter, the embodiments of the present invention will be described in detail with reference to the accompanying drawings. However, the invention may be embodied in many different forms and should not be construed as limited to the specific embodiments set forth. Rather, these embodiments are provided to explain the principles of the invention, and its practical application to enable those of ordinary skill in the art to understand various embodiments of the invention and various modifications which are suited to the particular use contemplated. In the drawings, the same reference numerals will always be used to refer to the same elements.

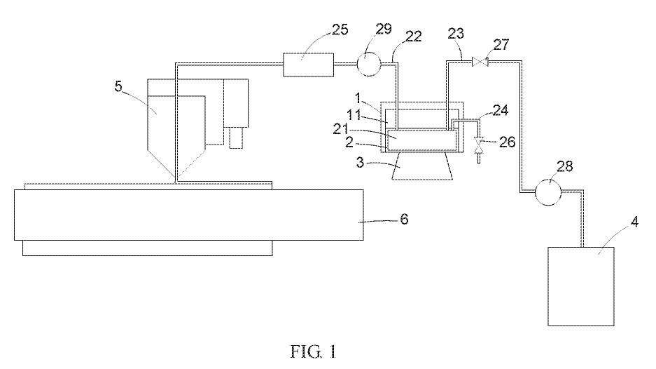

With reference to FIG. 1, this invention discloses a bubble removing device for PI solution. The bubble removing device comprises a first container 1, a second container 2 disposed in the first container 1, and an ultrasonic generator 3 arranged on the first container 1. An intermediate material, such as water is loaded in the first container. The second container 2 is used for bubble removing, and it contains the PI solution. The first container 1 and the second container 2 can be cylinder and the first container is disposed vertically to save the location space.

The second container 2 is smaller than the first container 1. The first container 1 and the second container 2 are divided into a first cavity 11 and a second cavity 21 individually, and the first cavity 11 and the second cavity 21 are not connected with each other. The first cavity 11 contains water, the second cavity 21 contains PI solution, and an outlet pipe 22, an inlet pipe 23, and an air vent 24 are arranged in the second cavity in the second cavity 21. To be specific, the outlet pipe 22, the inlet pipe 23, and the air vent 24 are extending from the inside of the first container I to the outside of the first container 1. The outlet pipe 22 and the inlet pipe 23 are extending from the top of the first container 1, the air vent 24 is extending form the sidewall of the first container 1. The ultrasonic generator 3 is arranged on the bottom of the first container 1. Due to the vertical arrangement of the first container 1, the contacting surface between the second container 2 and the ultrasonic generator 3 is increased.

In the present invention, the ultrasonic generator 3 can be a conventional device without any specific limitation.

With reference to FIG. 1, a filter 25 is connected with the outlet pipe 22, and the filter is used for stopping the impurities in the PI solution to avoiding the sprayer form clogging.

With reference to FIG. 1, the second container 2 is disposed beneath the first container for getting cavitation effect delivered to the PI solution in the second container 2.

With reference to FIG. 1, the air vent 24 is connected with an air evacuation valve 26. To be specific, the air evacuation valve 26 is an electromagnetic valve for better automatic control on venting.

With reference to FIG. 1, the inlet pipe 23 is connected with a liquid inlet valve 27. To be specific, the liquid inlet valve 27 is an electromagnetic valve for achieving the automatic manufacturing.

In the present embodiment, the inlet pipe 23 is connected with a first pump 28 and a second pump 29 is connected with the outlet pipe 22, and is disposed between the filter 25 and the second container 2 to control the inlet and outlet of the PI solution.

In the present embodiment, the bubble removing device further comprises a controller, used for controlling the air evacuation valve 26, the ultrasonic generator 3, the liquid inlet valve 27, the first pump 28 and the second pump 29 for realizing the automatic manufacturing.

With reference to FIG. 1, the present invention also discloses a coating apparatus. The coating apparatus comprises a storage container 4, a sprayer 5, a coating platform 6, and a bubble removing device for polyimide solution. The device comprises a first container 1, a second container 2 disposed in the first container 1, and an ultrasonic generator 3 arranged on the first container 1. An intermediate material, such as water is loaded in the first container. The second container 2 is used for bubble removing, and it contains the PI solution. The first container 1 and the second container 2 can be cylinder and the first container is disposed vertically to save the location space. The second container 2 is smaller than the first container 1. The first container 1 and the second container 2 are divided into a first cavity 11 and a second cavity 21 individually, and the first cavity 11 and the second cavity 21 are not connected with each other. The first cavity 11 contains water, the second cavity 21 contains PI solution, and an outlet pipe 22, an inlet pipe 23, and an air vent 24 are arranged in the second cavity. The sprayer 5 is connected with the outlet pipe 22 and the inlet pipe 23 is connected with the storage container 4.

To be specific, the outlet pipe 22, the inlet pipe 23, and the air vent 24 are extending from the inside of the first container 1 to the outside of the first container 1. The outlet pipe 22 and the inlet pipe 23 are extending from the top of the first container 1, the air vent 24 is extending form the sidewall of the first container 1. The ultrasonic generator 3 is arranged on the bottom of the first container 1. Due to the vertical arrangement of the first container 1, the contacting surface between the second container 2 and the ultrasonic generator 3 is increased. A filter 25 is connected with the outlet pipe 22. The filter 25 is used for stopping the impurities in the PI solution to avoiding the sprayer form clogging.

The second container 2 is disposed beneath the first container for getting cavitation effect delivered to the PI solution in the second container 2.

The air vent 24 is connected with an air evacuation valve 26. To be specific, the air evacuation valve 26 is an electromagnetic valve for better automatic control on venting.

The inlet pipe 23 is connected with a liquid inlet valve 27. To be specific, the liquid inlet valve 27 is an electromagnetic valve for achieving the automatic manufacturing.

The inlet pipe 23 is connected with a first pump 28 and a second pump 29 is connected with the outlet pipe 22, and is disposed between the filter 25 and the second container 2 to control the inlet and outlet of the P1 solution.

The coating apparatus further comprises a controller, used for controlling the air evacuation valve 26, the ultrasonic generator 3, the liquid inlet valve 27, the first pump 28 and the second pump 29 for realizing the automatic manufacturing.

The process of removing bubbles in the P1 solution is listed as below. The PI solution is piped in the second container 2 via the liquid inlet valve 27 and the inlet pipe. Under the performance of the ultrasonic generator, the cavitation effect is generated on the water of the first container I, and is delivered to the PI solution in the second container. The gas in the PI solution will get together accordingly to form fine bubbles. The fine bubbles will combine to form a ball shaped bubble and leave the PI solution surface. Then, the gas evacuation valve 26 is opened, and the gas is vented. Then the PI solution is piped through the outlet pipe 22 by the second pump 29, and sprayed via the sprayer 5 after filtering by the filter 25.

This invention provides a PI solution treatment method of the ultrasonic treatment to remove the gas in the solution and avoid the disadvantages, the water as the intermediate material will deliver the cavitation effect to the PI solution in the second container. The gas in the PI solution will gather to form fine bubbles. The fine bubbles will combine to form ball shaped bubbles and leave the PI solution. This realizes gas removing in P1 solution and improves the throughput, and this also control the vaporization of the solution with low boiling point to ensure the PI concentration is stable.

The above descriptions are merely specific implementation manners of the present application. It should be noted that those skilled in the art may make some improvements and modifications without departing from the principle of the present application. These improvements and modifications also should be regarded as the scope of protection of this application.

What is claimed is:

1. A bubble removing device for polyimide solution, comprising a first container, a second container disposed in the first container, and an ultrasonic generator, wherein the second container is smaller than the first container, the first container and the second container are divided into a first cavity and a second cavity individually, and the first cavity and the second cavity are not connected with each other; wherein the first cavity contains water, the second cavity contains solution, and an outlet pipe, an inlet pipe, and an air vent are arranged in the second cavity in the second container.

2. The device according to claim 1, comprising a filter connected with the outlet pipe.

3. The device according to claim 1, wherein the second container is arranged beneath the first container.

4. The device according to claim 1, wherein the ultrasonic generator is disposed on the bottom of the first container.

5. The device according to claim 3, wherein the ultrasonic generator is disposed on the bottom of the first container.

6. The device according to claim 1, wherein the air vent is connected with an air evacuation valve.

7. The device according to claim 1, the inlet pipe is connected with a liquid inlet valve.

8. The device according to claim 7, wherein the inlet pipe is connected with a first pump.

9. The device according to claim 7, comprising a second pump connected with the outlet pipe, and disposed between the filter, the second container.

10. A coating apparatus, comprising a storage container, a sprayer, and a bubble removing device for polyimide solution, wherein the device comprises a first container, a second container disposed in the first container, and an ultrasonic generator, wherein the second container is smaller than the first container, the first container and the second container are divided into a first cavity and a second cavity individually, and the first cavity and the second cavity are not connected with each other; wherein the first cavity contains water, the second cavity contains solution, and an outlet pipe, an inlet pipe, and an air vent are arranged in the second cavity in the second container; and wherein the outlet pipe is connected with the sprayer and the inlet pipe is connected with the storage container.

11. The apparatus according to claim 10, comprising a filter connected with the outlet pipe.

12. The apparatus according to claim 10, wherein the second container is arranged beneath the first container.

13. The apparatus according to claim 10, wherein the second container is arranged beneath the first container.

14. The apparatus according to claim 12, wherein the ultrasonic generator is disposed on the bottom of the first container.

15. The apparatus according to claim 10, wherein the ultrasonic generator is disposed on the bottom of the first container.

16. The apparatus according to claim 10, wherein the air vent is connected with an air evacuation valve.

17. The apparatus according to claim 16, wherein the inlet pipe is connected with a first pump.

18. The apparatus according to claim 10, comprising a second pump connected with the outlet pipe, and disposed between the filter, the second container.
